(19) United States
(12) Patent Application Publication
(10) Pub. No.: US 2011/0249679 A1
(43) Pub. Date: Oct. 13, 2011

(54) METHOD FOR IMPLEMENTING FAST REROUTE

(75) Inventors: Ning Lin, Guangdong (CN); Xiaohong Qian, Guangdong (CN)

(73) Assignee: ZTE CORPORATION, Shenzhen City, Guangdong (CN)

(21) Appl. No.: 13/140,054

(22) PCT Filed: Aug. 31, 2009
(86) PCT No.: PCT/CN2009/073649

§ 371 Date: Jun. 16, 2011

(30) Foreign Application Priority Data
Dec. 16, 2008 (CN) 200810241251.3

(51) Int. Cl. H04L 12/56

(52) U.S. Cl. 370/400

(57) ABSTRACT

A method for implementing FRR comprising_starting up an upper layer protocol software to manage and configure a FRR route; an upper layer protocol software sending down a active next hop of the FRR; a driver writing an IP address of the FRR into an ECMP table and creating a software table to record correspondence between a FRR group and ECMP group; informing the driver of a prefix address of a subnet route and the index of the FRR group, and the driver finding the index of the ECMP group, and writing information of the subnet route and the index of the ECMP group into hardware; an upper layer protocol software informing the driver of the index of the FRR and an IP address of a new standby next hop; the driver looking up for the index of the ECMP group, and updating the next hop address of the ECMP group.

### TECHNICAL FIELD

The present invention relates to a method for implementing Fast Reroute (FRR) in the driver layer.

### BACKGROUND OF THE RELATED ART

Fast Reroute (FRR) is to transfer the signaling and data to another pre-established path to ensure that the service will not be interrupted when a Label Switched Path (LSP) fails and cannot transmit the signaling and data properly. So FRR can be taken as a protection measure.

There are two different types of protection schemes in FRR:

1. Path protection, also called end-to-end protection, in which an extra LSP parallel to the existing LSP is established and only used when the existing LSP is invalid.

2. Partial protection, also called local protection, in which the backup LSP is just used to protect part of the original LSP. Wherein, according to the different protected objects, the way which is used to protect the node of the LSP is called node protection while the way which is used to protect the link of the LSP is called link protection.

At present, the commonly used FRR switch requires fast switch in general, usually within 50 ms. Normally, the FRR is processed by the network processor (NP) when the FRR is performed on the devices that contain a NP. But there are usually no corresponding FRR hardware table entries on the Application Specific Integrated Circuit (ASIC) chips, so the former way to implement the FRR function in driver layer is to delete the original old invalid route and further add a new route by the upper layer for transfer when performing switch. The disadvantage of this method is the switch time cannot fulfill the time requirement when FRR performs switch on the condition that there is a large amount of routes corresponding to an invalid LSP and consequently a large amount of times for asking the driver to delete the routes are required.

Until now the Chinese patent CN200710166107.3, CN200710175346.5 and CN200710105840 all provide methods for implementing FRR in the protocol layer, and a drawback of the methods is having the improvement of the switch speed in the chip layer unconsidered. As it is impossible to modify the chip function of the ASIC chips, it is necessary to use the existing table entity function of the chips, instead of encoding as performed on NP chips, to implement the FRR function. Besides that, most of the commercial available switch chips do not provide table entities special for FRR function; however they all provide table entity management function for equal-cost multi-path routing (ECMP).

Content of the Invention

The technical problem to be solved by the present invention is to provide a FRR method, which overcomes the problem that the switching time cannot meet the requirement as a result of the driver deleting the routes too many times during FRR switch.

According to one aspect of this invention, a fast reroute method is provided. The FRR method according to the present invention comprises the following steps of: a. a system starting up an upper layer protocol to manage and configure a FRR route; b. an upper layer sending down a active next hop of the FRR and allocating an index for the FRR different from an index of equal-cost multi-path routing (ECMP) group; a driver writing an IP address of the active next hop of the FRR into an ECMP table of a chip and creating a software table to store correspondence between a FRR group and the corresponding ECMP group on the chip; c. informing the driver of a prefix address of a subnet route and the index of the FRR group, and the driver finding the corresponding index of the ECMP group in the software table according to the index of the FRR group, and writing information of the subnet route and the index of the ECMP group into hardware; d. an upper layer software informing the driver of the index of the FRR and an IP address of a new standby next hop when the address of the active next hop of the FRR group fails; the driver looking up the software table for the corresponding index of the ECMP group according to the index of the FRR, and updating the next hop of the ECMP group to the IP address of the new standby next hop to complete the FRR.

In the above step b, the driver writes the ECMP group into the chip by invoking a SDK function of the chip.

In the above step b, if the ECMP group of the chip supports writing one next hop, then one next hop is written, while if the ECMP group of the chip must supports two or more next hops, then two or more same next hops is written.

In the above step c, the next hop of the subnet route does not use an IP address, but is associated with the index of the FRR group.

In the above step d, the driver writes the IP address of the new active next hop of the FRR into the ECMP table on the chip by invoking a SDK function on the chip.

In the above step d, after the address of the ECMP table is updated, the software table in the step b is also updated.

As it can be seen from the above technical solution, compared with the existing methods, the solution put forward by the present invention can implement the fast operation method supporting FRR switch on the most ASIC chips supporting ECMP. Moreover, the switching speed will not be increased no matter how many subnet routes use the same FRR group, so as to improve the responding speed of the system designed with ASIC chips for the FRR switch and improve the system efficiency dramatically. Since the FRR speed is not affected by the subnet route number, it is more stable. Meanwhile, this solution makes ASIC chips also support FRR, so it is not necessary that NP chips have to be used for implementing this function. Additionally, the cost of the device developed using ASIC chips is much lower than that of the device developed using NP.

The other advantages and features of the present invention will be demonstrated in the following description, which becomes apparent partially in the description or are understood by applying the present invention. The purpose and other advantages of the present invention can be achieved or acquired from the written description, claims and structures of the accompanying drawings particularly pointed out.

### BRIEF DESCRIPTION OF DRAWINGS

The drawings are used to further illustrate the present invention. The drawings are provided as a part of the description and used to explain the present invention in conjunction with the embodiments of the present invention, but do not intend to limit the present invention. The drawings are as follows:

FIG. 1 is an illustration of the subnet routes establishing switch using the correspondence between the FRR group and the ECMP group in the method of the presented invention;

FIG. 2 is the overall processing flow chart in the method of the present invention;

FIG. 3 is the flow chart of the FRR group sending down processing in the method of the present invention;

FIG. 4 is the flow chart of the subnet route sending down processing using the FRR protection in the method of the present invention;

FIG. 5 is the flow chart of the next hop sending down processing by the upper layer in the FRR switch in the method of the present invention.

### PREFERRED EMBODIMENTS OF THE PRESENT INVENTION

Function Overview

The present invention provides a method for implementing the FRR function using the ECMP table supplied by the ASIC chip. In this application, the chip BCM56624 supplied by Broadcom Corporation is used as an example, but the technical solution is not limited to this chip. The fast switch function of FRR can be implemented in the driver layer using the ECMP table management interfaces as long as the ECMP table and the management interface related to the ECMP table are provided by the chip suppliers.

The basic idea of the solution is to write the FRR as an ECMP group into the ECMP table of the chip, and no matter how many subnet routes using the same FRR for switch, the only action required to take is to modify the content of the next hop of the ECMP group corresponding to the FRR for one time, i.e. switching the next hop of the EMCP group from the invalid next hop to a active next hop without deleting and adding the subnet route for several times as performed in the former method.

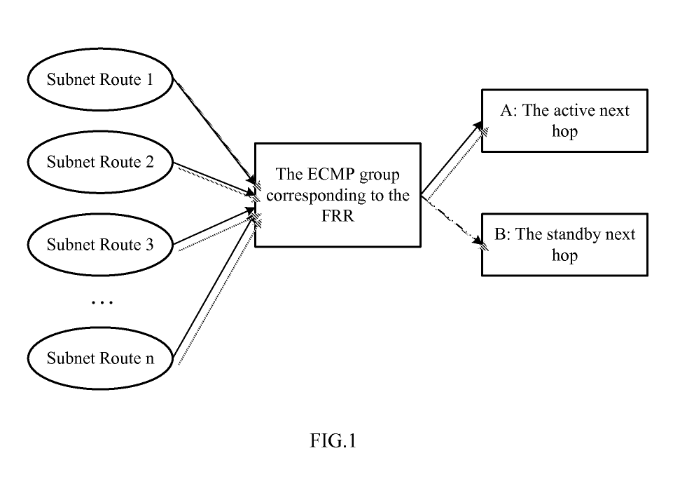

As shown in FIG. 1, though there are a plurality of subnet routes directing to the FRR group for switch, it does not need to process all of the subnet routes, but only need to switch the next hop of the ECMP group when switching if the ECMP group is used in implementation. For example, there are n subnet routes, and the next hop of these subnet routes are A and B, wherein A is the active next hop while B is the standby next hop. In this case, what is required to do is just to create one ECMP group, whose next hop is A, and once switch begins, just the next hop in this ECMP group is required to be switched into B to implement this FRR action, with deletion and addition of all the subnet routes are not required. As shown in FIG. 1, the FRR can be implemented only by switching the next hop indicated by solid line into the one indicated by dashed line.

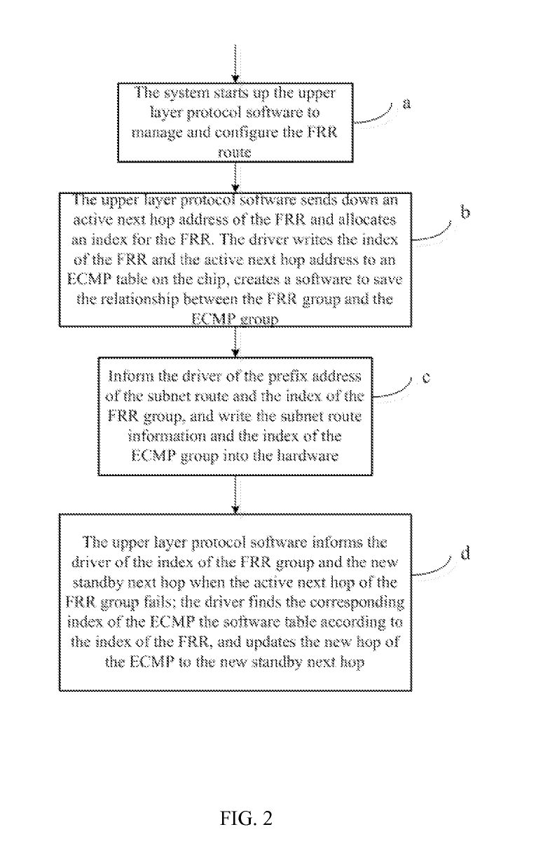

As shown in FIG. 2, the technical scheme of the present invention comprises the following steps:

a. The system starts up the upper layer protocol to manage and configure FRR route;

b. The upper layer protocol sends down the IP address of a active next hop of FRR to the driver layer, the sending down by the protocol layer and processing by the driver are performed according to the following three steps of:

b1. Allocating an index of the FRR, this index being different from that of the ECMP group allocated by the upper layer;

b2. Taking the IP address sent down as the active next hop of the index of the FRR, and informing the driver of the index of the FRR and the active next hop IP address;

b3. The driver writing the index of the FRR and the active next hop IP address into the ECMP table on the chip as the index of the ECMP group and the next hop IP address of the ECMP group respectively, and saving the index of the ECMP group which is written onto the chip. The writing operation onto the chip by the driver herein is in the same way with the operation of sending down the ECMP route by the operation upper layer, except that the group should be distinguished in the software table of the driver as whether it is sent down by the real ECMP group or by the active next hop of the FRR. Because the FRR shares the same next hop with the real ECMP during processing on the chip, the allocated index of the FRR should be different from the index of the real ECMP in the step b1.

c. Informing the driver of the prefix address of a subnet route and the index of the FRR group when the subnet route is required to backup of the link of the FRR group, and then the driver retrieving the correspondence between the index of the FRR group and the index of the ECMP group according to the index of the FRR group provided by the upper layer, and writing the subnet route information and the index of the ECMP into the hardware, as a result, the subnet route is directed to the EMCP group of the hardware. With such operations, the next hops of the subnet routes needing protection of the FRR group being all directed to the practically effective next hop of the ECMP group;

d. After the step c, the routes directing to the FRR group being able to implement the FRR for protection. Then, if the active next hop of the FRR group fails and is required to switch into the standby next hop, the operation is as follows:

d1. The upper software just needs to inform the driver of the index of the FRR and the IP address of the new standby next hop, and does not need to inform the driver of all the subnet routes referring to the FRR;

d2. The driver finds the index of the ECMP corresponding to the index of the FRR in the software table, and updates the IP address of the new standby next hop to the next hop of the ECMP to finish the FRR switch.

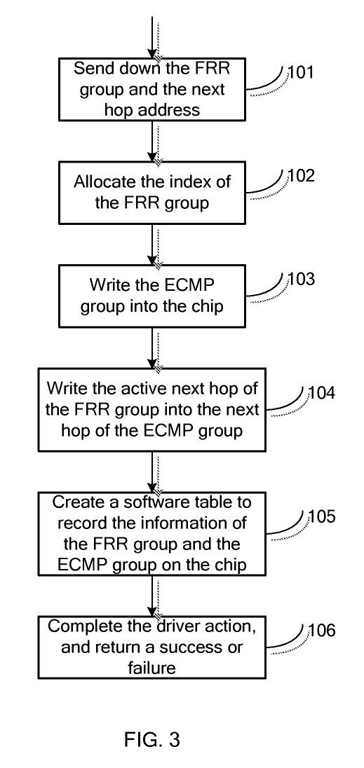

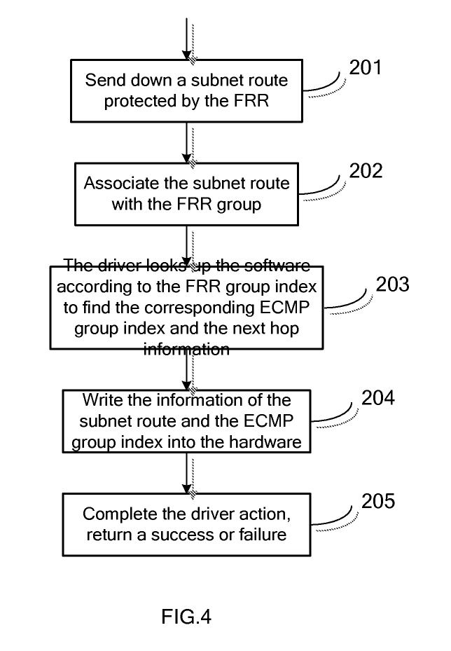

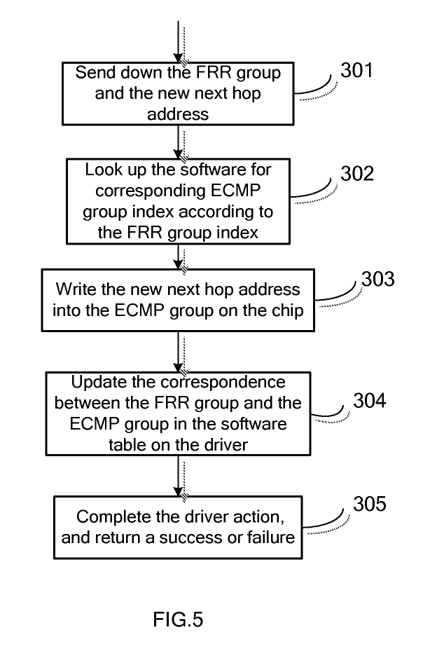

The step a and b are the operation of the upper layer writing the FRR group and the next hop to the driver, corresponding to FIG. 3; the step c is the operation of the upper layer writing in the subnet route requiring protection, corresponding to FIG. 4; the step d is the operation of the upper layer on the driver during the switch of the subnet route, corresponding to FIG. 5.

To make the technical scheme of present invention understood more clearly, herein an example is taken as follows: there is one subnet route 123.1.1.0, which has two next hops, the one being used is 123.1.1.1, and the other one being standby is 123.1.1.2.

The processing in step a and b is that the upper layer creates an FRR group A, in which the member is 123.1.1.1, and then the upper layer writes the group A to the driver. The driver layer creates an ECMP group a correspondingly and writes 123.1.1.1 to the ECMP group a; The processing in step c is that the upper layer sends down the subnet route 123.1.1.0, and informs the driver that the next hop of the subnet route is the FRR group A. Thus, the driver finds the ECMP group a according to the FRR group A, and then writes the information “the subnet route 123.1.1.0 +ECMP group a′ to the hardware. In this way, according to ECMP group a, the hardware can get that the next hop of 123.1.1.0 is the next hop 123.1.1.1 corresponding to the ECMP group a;

The processing in step d is that if 123.1.1.1 fails, and now it needs to reroute to 123.1.1.2. At this time, the upper layer sends down the switch information of the FRR group A, and informs the driver that the next hop of the FRR group A is not 123.1.1.1 anymore, and it has switched to the new 123.1.1.2. On receiving the information, the driver directly finds the ECMP group a according to the FRR group A, and modifies the next hop of the ECMP group a to be 123.1.1.2. By such modification, the subnet route 1231.1.0 directing to the ECMP group a just now has rerouted the next hop automatically.

The advantage of the method is that by informing the driver of the modification of the FRR group A directly, instead of sending down the detail information of each subnet routes, as can be seen from step d of the method, the next hops of all the subnet routes can be modified indirectly when there are plenty of routes besides 123.1.1.0 directing to the FRR group A.

The steps in FIG. 2 will be described specifically as follows, and FIG. 3, corresponding to the steps a and b in FIG. 2, illustrates the flow of FRR group sending down processing functions.

Step 101, sending down the FRR group and IP address of currently enabled next hop when the upper layer protocol enables the FRR function;

Step 102, allocating an index for the FRR group, which is different from the index of a real ECMP group sending down by the upper layer, to avoid the case of the index of the FRR group occupying the index of the real ECMP group;

Step 103, the driver takes the index allocated for the FRR group as the index of the ECMP table on the chip to invoke the SDK function, and writes the ECMP group onto the chip;

Step 104, the driver allocates and creates an ECMP group according to the index of the FRR group, and writes the active next hop of the FRR group to the ECMP group; herein, the writing should be based on the different circumstance of each different chip. If the ECMP group of the chip supports writing in a next hop, then a next hop can be written in, and if two or more next hops should be supported, then two or more same next hops can be written.

Step 105, a software table is created in the driver to save the relationship between the FRR group and the corresponding ECMP group on the chip, so that, when a subnet route is added, the index of ECMP group that ought to correspond to the index of the FRR group associated with the subnet route in the hardware can be retrieved;

Step 106, if the hardware table on the chip is written successfully by the driver, a success is returned, while, if the driver fails to write the hardware table, then a failure is returned.

FIG. 4 corresponds to the step c in FIG. 2, and is the flow chart of sending down subnet routes protected by the FRR:

Step 201, when there is a subnet route to be protected by FRR, the upper layer is required to send down the subnet route to the driver;

Step 202, the next hop of the subnet route does not use the IP address; instead, it is associated with the index of the FRR group protecting the subnet route;

Step 203, the driver looks up the software table established by the FRR group and ECMP group for the index of the ECMP group corresponding to the FRR group according to the index of FRR sent down by the upper layer protocol, and further gets the information of the next hop of the ECMP group;

Step 204, the index information of the ECMP table and the related information of the subnet route are written into the subnet table of the hardware on the chip; the next hop of the subnet route in the hardware directs to the found ECMP group. In this way, the subnet route for protection of FRR is related to the index of the ECMP group written into the hardware as a replacement of the FRR group.

The prefix of the subnet route is the content of the subnet route table to be written into the hardware, for example, 123.0.0.0 is the prefix of a subnet route. The subnet route table refers to the subnet route table in the hardware. When the subnet route is written, if the subnet route is of FRR type, it is necessary to find a corresponding index of the ECMP table and write it into the hardware as the next hop of the subnet route. Thus by knowing the next hop corresponding to the subnet route is an ECMP group, the hardware will find the ECMP group in the ECMP table. In addition, the ECMP group records one or more next hops, which is the real next hop of the subnet route.

Step 205, if the driver writes the hardware table on the chip successfully, a success is returned, or else, a failure is returned.

FIG. 5, corresponding to the step d in FIG. 2, is the flow chart of sending down by the upper layer when FRR switches a next hop.

Step 301, the upper layer sends down a FRR group and address of the new next hop when the FRR is performed; where this next hop is a standby next hop for the FRR group switching, and it is active at this time since the former next hop has been invalid.

Step 302, find the ECMP group in the software table to get the index of the ECMP group, and prepare to write the new next hop to be active to the hardware;

Step 303, update the content of the ECMP group on the chip; By invoking the SDK function on the chip, write IP address of the new active next hop into the ECMP group to take the place of the former invalid one to complete the action of switching the next hop in the hardware. The former next hop will not work.

Step 304, update the relationship table of the FRR group and the ECMP group in the software table, write the new next hop into the next hop of the ECMP group and delete the former next hop to synchronize the software table and the hardware table on the chip;

Step 305, if the hardware table on the chip is written successfully by the driver, a success is returned, or else, a failure is returned.

The above description is just preferred embodiments of the present invention, and does not intend to limit the present invention. For those having ordinary skills in the art, the present invention may have various modifications and variations. However, all the modification, equivalent replacement and improvement made under the spirit and principle of the present invention shall be contained in the protection scope of the present invention.

### INDUSTRIAL APPLICABILITY

Compared with the existing methods, the solution put forward by the present invention can implement the fast operation method supporting FRR switch on the most ASIC chips supporting ECMP. Moreover, the switching speed will not be increased no matter how many subnet routes use the same FRR group, so as to improve the responding speed of the system designed with ASIC chips for the FRR switch and improve the system efficiency dramatically. Since the FRR speed is not affected by the subnet route number, it is more stable. Meanwhile, this solution makes ASIC chips also support FRR, so it is not necessary that NP chips have to be used for implementing this function. Additionally, the cost of the device developed using ASIC chips is much lower than that of the device developed using NP.

1. A method for implementing fast reroute (FRR), comprising the following steps of:
a.) a system starting up an upper layer protocol software to manage and configure a FRR route;
b.) an upper layer protocol software sending down a active next hop of the FRR and allocating an index for the FRR different from an index of equal-cost multi-path routing (ECMP) group; a driver writing an IP address of the active next hop of the FRR into an ECMP table of a chip and creating a software table to store correspondence between a FRR group and the corresponding ECMP group on the chip;
c.) informing the driver of a prefix address of a subnet route and the index of the FRR group, and the driver finding the corresponding index of the ECMP group in the software table according to the index of the FRR group, and writing information of the subnet route and the index of the ECMP group into hardware; and
d.) an upper layer protocol software informing the driver of the index of the FRR and an IP address of a new standby next hop when the address of the active next hop of the FRR group fails; the driver looking up the software table for the corresponding index of the ECMP group according to the index of the FRR, and updating the next hop of the ECMP group to the IP address of the new standby next hop to complete the FRR.

2. The method as claimed in claim 1, wherein in the step b, the driver writes the ECMP group into the chip by invoking a software development kit (SDK) function of the chip.

3. The method as claimed in claim 1, wherein in the step b, if the ECMP group of the chip supports writing one next hop, then one next hop is written, while if the ECMP group of the chip must supports two or more next hops, then two or more same next hops is written.

4. The method as claimed in claim 1, wherein in the step c, the next hop of the subnet route does not use an IP address, but is associated with the index of the FRR group.

5. The method as claimed in claim 1, wherein in the step d, the driver writes the IP address of a new active next hop of the FRR into the ECMP table on the chip by invoking a software development kit (SDK) function on the chip.

6. The method as claimed in claim 1, wherein in the step d, after the address of the ECMP table is updated, the software table in the step b is also updated.
